(19) United States
(12) Patent Application Publication
(10) Pub. No.: US 2010/0264598 A1
(43) Pub. Date: Oct. 21, 2010

(54) APPARATUS OF BILGE PREVENTION FOR A SHIP

(76) Inventors: Seok Jin Kim, Gyeongsangnam-do (KR); Young Ho Ban, Gyeongsangnam-do (KR); Kwang Uk Kang, Gyeongsangnam-do (KR)

Correspondence Address: HOSOON LEE, 9600 SW OAK ST. SUITE 525, TIGARD, OR, 97223, US

(21) Appl. No.: 12/742,084

(22) PCT Filed: Oct. 29, 2008
(86) PCT No.: PCT/KR08/06381

§ 371 Date: May 26, 2010

(30) Foreign Application Priority Data
Nov. 8, 2007 (KR) 10-2007-0113782

(51) Int. Cl. B63H 23/32; F16J 15/34; F16J 15/38

(52) U.S. Cl. 277/377; 277/345; 277/390

(57) ABSTRACT

Disclosed is an apparatus (1) for preventing generation of bilge water in a ship. The apparatus includes a cover (7) configured to receive fluid therein, a rotating unit (3) coupled to a shaft (91) so as to be rotated along with the shaft penetrated through the rotating unit, the rotating unit including a first coupler (31). The apparatus further includes a first sealing unit (4) located inside the cover and interposed between one side of the first coupler and one side of the cover, and a sealing piece (6) interposed in a contact interface between the rotating unit and the shaft. The apparatus completely prevents seawater from being introduced into an engine room, therby preventing generation of bilge water and achieving an extended lifespan thereof without damage.

### TECHNICAL FIELD

The present invention relates to ships, and more particularly, to an apparatus for preventing generation of bilge water in a ship, which can prevent generation of bilge water caused as seawater introduced into an engine room of the ship is mixed with a variety of contaminants to thereby be accumulated in the engine room.

### BACKGROUND ART

In general, to acquire a propulsion force required for sailing, a ship includes an engine disposed in a specific position of the ship, a propeller mounted to the exterior of a rear end of the ship, and a shaft to connect the engine and propeller to each other.

The shaft is installed to penetrate through the rear end of the ship to thereby be connected to the propeller and serves to rotate the propeller when rotated by the engine. In this case, to assure effective rotation of the shaft, the shaft must be installed to the ship such that a gap of a predetermined distance is defined between the shaft and the rear end of the ship. Otherwise, due to friction caused between the shaft and the rear end of the ship during rotation of the shaft, there are risks of loss of drive power of the engine and damage to the rear end of the ship as well as the shaft.

However, such a gap between the shaft and the rear end of the ship inevitably causes seawater to be introduced into the interior of the ship. Seawater introduced into the ship is mixed with a variety of contaminants, such as fuel, engine oil, and various other lubricants, within an engine room, resulting in generation of bilge water. As is known, bilge water causes corrosion of elements within the engine room and also, is a main cause of sea pollution.

Recently, sea pollution due to bilge water has become an international issue and thus, regulations with relation to treatments of bilge water generated in a ship are more strictly enforced. On the basis of the environmental protection laws thereof, most countries strictly prohibit directly discharging bilge water out of a ship, and allow discharge only of bilge water subjected to purification. Even in this case, if the resulting purified bilge water does not satisfy a criterion value of allowable oil content, discharging bilge water out of a ship is still prohibited.

With a recent trend of gradually reinforcing regulations related to bilge water, specific countries or areas have reinforced the criterion value of allowable oil content from a conventional criterion value of 15 ppm to 5 ppm. Even in the case of the International Maritime Organization that is influential throughout the world, it is expected that the organization will reinforce the criterion value from 15 ppm to 5 ppm.

However, conventional methods for purifying bilge water have a limit in purification efficiency and are troublesome because of a necessity for periodic inspection of a purifying system. Moreover, as for poorly-equipped fishermen managing ultra-small ships, preparation of a purifying system entails an economical burden and complexity in operation. For this reason, generally, most poorly-equipped fishermen secretly discharge bilge water without purification.

Therefore, to protect ships from bilge water while preventing sea pollution, proposals have been made to prevent generation of bilge water in advance by interrupting introduction of seawater into ships, rather than purifying bilge water.

FIG. 1 is a sectional view of a conventional stern tube shaft sealing device.

Considering first the configuration of a general ship engine unit with reference to FIG. 1 in brief, the engine unit includes a propeller 13 to generate a ship propulsion force, an engine 14 to provide the propeller 13 with rotating power, and a shaft 15 to connect the engine 14 and propeller 13 to each other.

The conventional stern tube shaft sealing device, proposed to prevent generation of bilge water in a ship, includes a hull sealing unit 11 configured to be secured to a ship's hull and a sealing member 12.

The hull sealing unit 11 is mounted to a rear end 16 of the hull and in turn, the shaft 15 is rotatably penetrated through the hull sealing unit 11 so as to prevent introduction of seawater. The hull sealing unit 11 includes a stern tube 111, a grand packing 112, a bearing 113, and a grand packing cover 114.

The stern tube 111 is secured to the rear end 16 of the hull. The grand packing 112 and bearing 113 are received inside the stern tube 111. To allow the stern tube 111 to be secured to the rear end 16 of the hull using fasteners, the stern tube 111 has a stern tube flange 111a. The stern tube 111 is secured to the rear end 16 of the hull, to maintain a gap 111b of a predetermined distance with the shaft 15 for rotation of the shaft 15.

The grand packing 112 serves to seal only a partial region of the gap 111b, so as to allow a predetermined amount of seawater to be introduced through the gap 111b. This allows the seawater, introduced through the gap 111b, to be used for removal of frictional heat generated from the shaft 15. In this way, the grand packing 112 is able to prevent damage to the shaft 15 due to frictional heat.

The bearing 113 serves to limit movement of the shaft 15, thereby preventing unexpected collision between the shaft 15 and the stern tube 111. The shaft 15 is penetrated through the bearing 113 such that the shaft 15 is disposed inside the stern tube 111. A lignum vitae bearing may be used as the bearing 113.

The grand packing cover 114 serves to regulate a sealing degree by applying a pressure to the grand packing 112. The grand packing cover 114 is partially inserted into the stern tube 111 such that it is fixedly coupled to the stern tube 111. The grand packing cover 114 is fixedly coupled to the stern tube 111 via the flange 114a.

The sealing member 12 serves to interrupt the predetermined amount of seawater introduced through the hull sealing unit 11, thereby preventing generation of bilge water. The shaft 15 is penetrated through the sealing member 12 and is coupled to the exterior of the grand packing cover 114.

The sealing member 12 includes a fixing ring 121, a sealing ring 122, a rotating ring 123, and a holder cover 124.

The fixing ring 121 is coupled closely, at one side thereof, to the grand packing cover 114, and at the other side thereof, to the sealing ring 122.

The sealing ring 122 is interposed between the fixing ring 121 and the rotating ring 123, and serves to completely prevent introduction of seawater. The sealing ring 122 is an essential sealing element of the sealing member 12.

The rotating ring 123 is rotated along with the shaft 15 and is coupled closely to the sealing ring 122. Since the sealing ring 122 interrupts introduction of seawater, no seawater reaches contact surfaces of the rotating ring 123 and sealing ring 122.

The holder cover 124 contains a spring 124a therein, and is fixedly coupled to both the shaft 15 and the rotating ring 123. The holder cover 124 is rotated simultaneously with rotation of the shaft 15.

The above-described conventional stern tube shaft sealing device 10 has the following problems.

Firstly, the rotating ring 123 is rotated along with the shaft 15 upon rotation of the shaft 15, but the sealing ring 122 is not rotated even though the shaft 15 is rotated. Therefore, frictional heat is inevitably generated from the contact surfaces of the rotating ring 123 and sealing ring 122. The frictional heat may problematically cause damage to or breakage of any one of the rotating ring 123 and sealing ring 122.

Secondly, to prevent any one of the rotating ring 123 and sealing ring 122 from being damaged or broken by the frictional heat, it is necessary to remove the frictional heat via cooling. However, the conventional stern tube shaft sealing device 10 is configured to prevent seawater from being introduced to the contact surfaces of the rotating ring 123 and sealing ring 122, and cannot prevent damage to both the elements.

Thirdly, the larger the size of a ship, the faster the rotation speed of the shaft 15 required to achieve a ship propulsion force. In proportion to the faster rotation speed, the frictional heat generated from the contact surfaces of the rotating ring 123 and sealing ring 122 is increased, causing the sealing member 12 to be seriously damaged or broken within a short time after starting. This damage or breakage results in generation of bilge water, which entails risks of sea pollution and ship foundering.

### DISCLOSURE OF INVENTION

### Technical Problem

Therefore, the present invention has been made in view of the above problems, and it is an object of the present invention to provide an apparatus for preventing generation of bilge water in a ship, which can prevent seawater from being introduced into an engine room, thereby completely preventing generation of bilge water and achieving an extended lifespan thereof without damage.

### Technical Solution

In accordance with an aspect of the present invention, the above and other objects can be accomplished by the provision of an apparatus for preventing generation of bilge water in a ship including: a cover configured to receive fluid therein; a rotating unit coupled to a shaft so as to be rotated along with the shaft penetrated through the rotating unit, the rotating unit including a first coupler; a first sealing unit located inside the cover and interposed between one side of the first coupler and one side of the cover; and a sealing piece interposed in a contact interface between the rotating unit and the shaft.

The apparatus may further include a cover flange coupled to one side of the cover; and a second sealing unit located inside the cover and interposed between the other side of the first coupler and the cover flange.

### Advantageous Effects

According to the present invention, the following effects can be accomplished.

An apparatus for preventing generation of bilge water in a ship according to the present invention is configured to completely prevent seawater from being introduced into an engine room, thereby being capable of preventing generation of bilge water. According to the present invention, cooling of any frictional regions is accomplished using seawater or other fluids, resulting in an extended lifespan of the apparatus without damage.

In addition, the apparatus generally has a simplified configuration and thus, can be mounted to a ship in a simplified manner for preventing generation of bilge water in the ship. Accordingly, the apparatus for preventing generation of bilge water in a ship also functions to protect elements inside the engine room, resulting in an extended lifespan of the ship. The present invention can contribute to environmental protection by completely eliminating a possibility of sea pollution due to bilge water, which has now become an international issue.

### BRIEF DESCRIPTION OF DRAWINGS

The above and other objects, features and other advantages of the present invention will be more clearly understood from the following detailed description taken in conjunction with the accompanying drawings, in which:

FIG. 1 is a sectional view of a conventional stern tube shaft sealing device;

FIG. 2 is an exploded perspective view illustrating a partial configuration of an apparatus for preventing generation of bilge water in a ship in accordance with an embodiment of the present invention;

FIG. 3 is a sectional view illustrating a state wherein the apparatus for preventing generation of bilge water in a ship shown in FIG. 2 is mounted to a ship;

FIG. 4 is an enlarged sectional view of the portion A in FIG. 3;

FIG. 5 is an assembled perspective view of the apparatus for preventing generation of bilge water in a ship in accordance with the embodiment of the present invention;

FIG. 6 is an exploded perspective view illustrating a partial configuration of an apparatus for preventing generation of bilge water in a ship in accordance with another embodiment of the present invention;

FIG. 7 is a sectional view illustrating a state wherein the apparatus for preventing generation of bilge water in a ship shown in FIG. 6 is mounted to a ship; and

FIG. 8 is an enlarged sectional view of the portion B in FIG. 7.

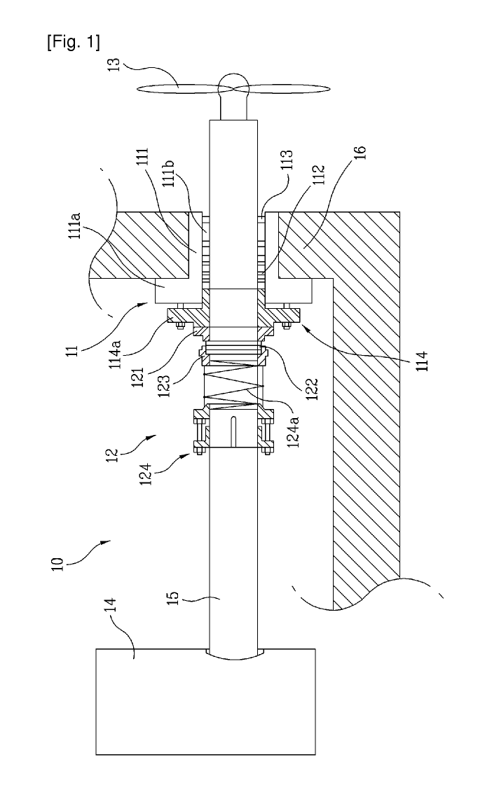

### BEST MODE FOR CARRYING OUT THE INVENTION

Hereinafter, preferred embodiments of an apparatus for preventing generation of bilge water in a ship in accordance with the present invention will be described in detail with reference to the accompanying drawings. In the following description, two embodiments of the apparatus for preventing generation of bilge water in a ship in accordance with the present invention will be described in sequence.

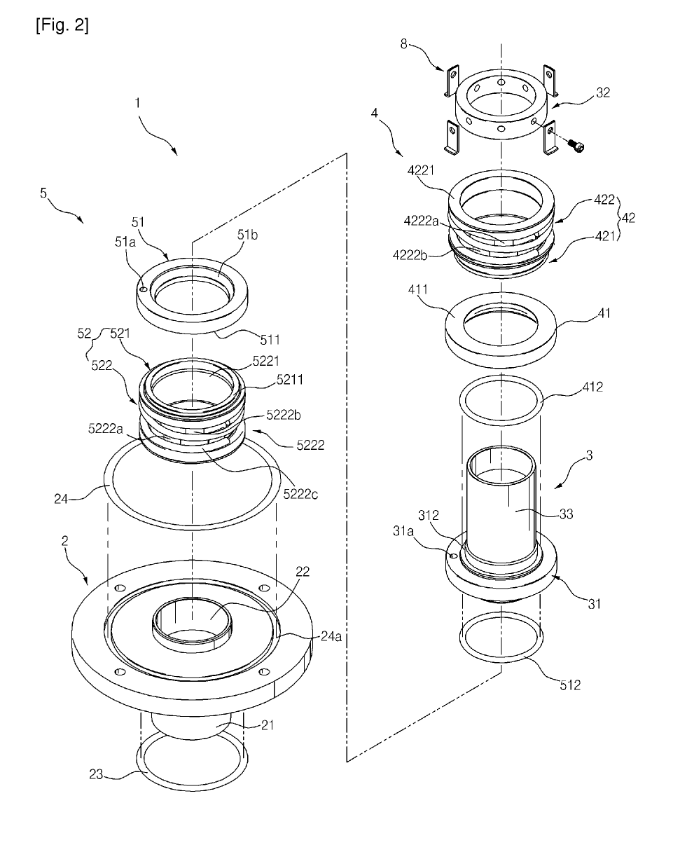

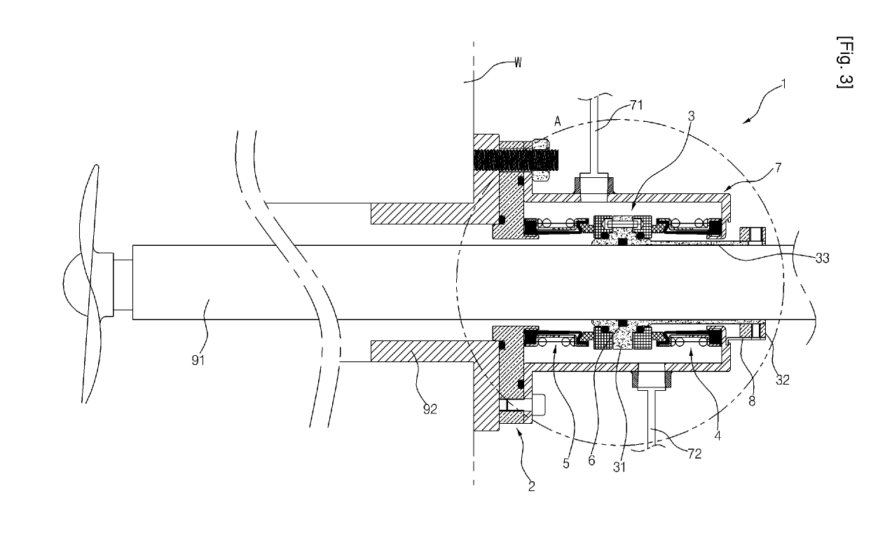

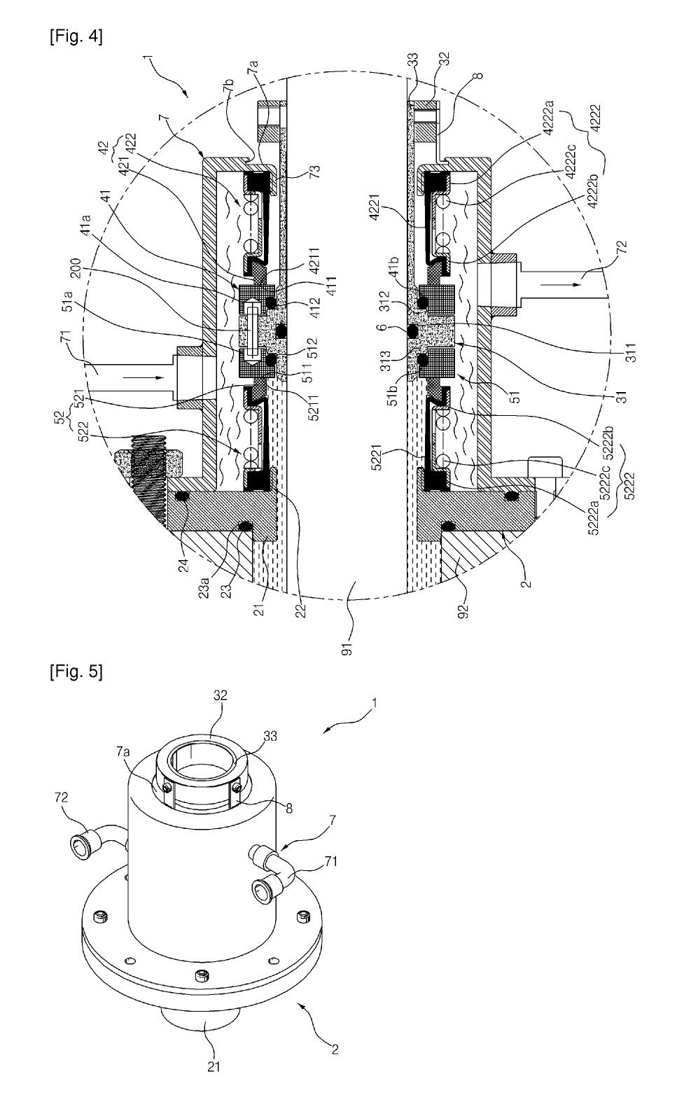

FIG. 2 is an exploded perspective view illustrating a partial configuration of an apparatus for preventing generation of bilge water in a ship in accordance with an embodiment of the present invention, FIG. 3 is a sectional view illustrating a state wherein the apparatus for preventing generation of bilge water in a ship show in FIG. 2 is mounted to a ship, and FIG. 4 is an enlarged sectional view of the portion A in FIG. 3. Also, FIG. 5 is an assembled perspective view of the apparatus for preventing generation of bilge water in a ship in accordance with the embodiment of the present invention.

Referring to FIGS. 2 and 3, the apparatus for preventing generation of bilge water in a ship in accordance with an exemplary embodiment of the present invention, which is designated by reference numeral 1, includes a cover flange 2, a rotating unit 3, a first sealing unit 4, a second sealing unit 5, a sealing piece 6, and a cover 7.

The cover flange 2 is coupled to one end of the cover 7 and is also coupled to the second sealing unit 5. The cover flange 2 has a hollow disk form, and a shaft 91 is penetrated through the center of the cover flange 2. The cover flange 2 may be made of at least any one of stainless steel, titanium, and hastelloy-C. Alternatively, the cover flange 2 may be made of plastic, to make the apparatus 1 light weight.

The cover flange 2 may be coupled to a stern tube 92. Specifically, the cover flange 2 may be coupled to the stern tube 92 such that the cover flange 2 is spaced apart from the shaft 91 by a predetermined distance so as not to come into contact with the shaft 91.

Although not shown, the cover flange 2 may be coupled to any one of a wall surface W of an engine room or bushing (not shown), instead of the stern tube 92. That is, in consideration of ship installation options or convenience of installation, a worker is able to couple the cover flange 2 to any one of the wall surface W of the engine room, stern tube 92 and bushing (not shown).

The cover flange 2 may include an inserting portion 21, a flange protrusion 22, a flange packing member 23, and a cover packing member 24.

The inserting portion 21 protrudes from one side of the cover flange 2 and may have a hollow disk form. When the cover flange 2 is coupled to the stern tube 92, the inserting portion 21 is inserted into the stern tube 92. Using the inserting portion 21 enable a worker to easily mount the apparatus 1 to the ship.

Referring to FIGS. 2 and 4, the flange protrusion 22 protrudes from the other side of the cover flange 2 and may have a hollow disk form. As show in FIG. 4, the second sealing unit 5 may be caught by and coupled to the flange protrusion 22.

The flange packing member 23 is fitted into a packing groove 23a (See FIG. 4) formed in one side of the cover flange 2, and serves to seal a coupling interface between the cover flange 2 and the stern tube 92. The flange packing member 23 may be an O-ring, and in particular, may be an O-ring made of fluorine rubber (FPM).

Although not shown, a plurality of flange packing members 23 may be provided. In this case, the cover flange 2 may be formed with a plurality of packing grooves 23a corresponding to the number of the flange packing members 23.

Although not shown, when the cover flange 2 is coupled to any one of the wall surface W of the engine room or bushing (not shown) instead of the stern tube 92, the flange packing member 23 may be coupled to one side of the cover flange 2 so as to seal a coupling interface between the cover flange 2 and the wall surface W or bushing (not shown).

The cover packing member 24 is fitted into a groove 24a formed in the other side of the cover flange 2 and serves to seal a coupling interface between the cover flange 2 and the cover 7. The cover packing member 24 may be an O-ring, and in particular, may be an O-ring made of fluorine rubber (FPM).

Referring to FIGS. 2 to 4, the shaft 91 is penetrated through the center of the rotating unit 3 while being coupled to the rotating unit 3, such that the rotating unit 3 is rotated along with the shaft 91. The rotating unit 3 may be made of at least any one of stainless steel, titanium, and hastelloy-C.

The rotating unit 3 includes a first coupler 31, a second coupler 32, and a connector 33.

The first coupler 31 is coupled, at opposite sides thereof, with the first sealing unit 4 and the second sealing unit 5, respectively. The first coupler 31 may have a hollow disk form. The rotating unit 3 may be coupled to the shaft 91 such that the first coupler 31 is located inside the cover 7. The first coupler 31 is perforated with a fastening hole 31a such that the first coupler 31 can be coupled with the first and second sealing units 4 and 5 using a pin 200 (See FIG. 4).

The first coupler 31 is further formed with a sealing groove 311 (See FIG. 4). The sealing piece 6 is fitted into the sealing groove 311. The sealing groove 311 is formed in an inner peripheral surface of the first coupler 31 defining a penetration bore through which the shaft 91 is penetrated. The sealing groove 311 may have a shape corresponding to the sealing piece 6.

The first coupler 31 includes a first support 312 and a second support 313.

The first support 312 is used to support a first packing member 412, which is provided to seal a coupling interface between the rotating unit 3 and the first sealing unit 4. The first support 312 is a stepped portion defined at one side of the first coupler 31 and may have a hollow disk form.

The second support 313 is used to support a second packing member 512, which is provided to seal a coupling interface between the rotating unit 3 and the second sealing unit 5. The second support 313 is a stepped portion defined at the other side of the first coupler 31 and may have a hollow disk form.

The second coupler 32 is spaced apart from the first coupler 31 by a predetermined distance such that it is coupled to the shaft 91 at the outside of the cover 7. The second coupler 32 is perforated with a plurality of fastening holes, through which fasteners to couple the second coupler 32 and shaft 91 to each other are inserted. The second coupler 32 may have a hollow disk form and may be coupled to a distal end of the connector 33 using a fastener.

The connector 33 serves to connect the first coupler 31 located inside the cover 7 and the second coupler 32 located at the outside of the cover 7 to each other. The connector 33 may take the form of a hollow cylinder extending from the interior of the cover 7 to the outside of the cover 7 by a long length. The connector 33 may be integrally formed with the first coupler 31.

Referring to FIGS. 2 to 4, the first sealing unit 4 is located inside the cover 7 and is interposed between one side of the first coupler 31 and a corresponding side of the cover 7.

The first sealing unit 4 may be interposed between one side of the first coupler 31 and the corresponding side of the cover 7 so as to be spaced apart from the shaft 91 by a predetermined distance. With this arrangement, even if the shaft 91 deviates from an original position thereof, for example, is tilted by a predetermined angle according to sailing conditions of the ship, the first sealing unit 4 can normally perform a desired sealing function.

The first sealing unit 4 includes a first frictional rotator 41 and a first stator 42.

The first frictional rotator 41 is coupled to one side of the first coupler 31 and is rotated along with the rotating unit 3 and shaft 91 simultaneously with rotation of the shaft 91. The first frictional rotator 41 has a hollow disk form.

The first frictional rotator 41 is inserted into and coupled to the rotating unit 3 so as not to come into contact with the shaft 91. This coupling manner reduces a total contact area between the shaft 91 and other elements, minimizing damage to the shaft 91 and other elements.

The first frictional rotator 41, as shown in FIG. 4, is formed with a groove 41a in a surface thereof to be coupled to the first coupler 31, such that the first frictional rotator 41 can be coupled to one side of the first coupler 31 using the pin 200 (See FIG. 4).

The first frictional rotator 41 is defined with a first frictional rotational plane 411 and contains a first packing member 412.

The first frictional rotational plane 411 is brought into frictional contact with the first stator 42 upon rotation of the shaft 91. The first frictional rotational plane 411 may be made of any one of highly wear-resistant silicon carbide, tungsten carbide, or carbon graphite. The entire first frictional rotator 41 may be made of the same material as that of the first frictional rotational plane 411.

Accordingly, in the apparatus for preventing generation of bilge water in a ship in accordance with the present invention, any elements subjected to friction upon rotation of the shaft 91 are made of highly wear-resistant materials, resulting in a reduction in frictional damage thereof and enabling long-term use without exchange.

The first packing member 412 is fitted into a receiving groove 41b (See FIG. 4) defined in the first frictional rotator 41 and serves to seal a coupling interface between the first frictional rotator 41 and the first coupler 31. The first packing member 412 is supported by the first support 312. The first packing member 42 may be an O-ring and in particular, may be an O-ring made of fluorine rubber (FPM).

The first stator 42 is interposed between the first frictional rotator 41 and a corresponding side of the cover 7. The first stator 42 comprises a first frictional stationary piece 421 and a first press piece 422.

The first frictional stationary piece 421 is brought into contact with the first frictional rotator 41 upon receiving a pressure applied by the first press piece 422. The first frictional stationary piece 421 has a hollow disk form. The first frictional stationary piece 421 is defined with a first frictional stationary plane 4211.

The first frictional stationary plane 4211 is brought into frictional contact with the first frictional rotational plane 411 upon rotation of the shaft 91. The first frictional stationary plane 4211 may be made of any one of highly wear-resistant silicon carbide, tungsten carbide, or carbon graphite.

The first frictional stationary plane 4211 may be made of a different material from that of the first frictional rotational plane 411. The entire first frictional stationary piece 421 may be made of the same material as that of the first frictional stationary plane 4211.

Here, note that no packing member is interposed between the first frictional stationary plane 4211 and the first frictional rotational plane 411. This allows the first frictional stationary plane 4211 and first frictional rotational plane 411 to come into strong close contact with each other via operation of the first press piece 422 and also, eliminates a risk of leakage of fluid received within the cover 7 via frictional removal of the fluid.

In other words, the fluid received within the cover 7 acts to remove frictional heat generated between the first frictional stationary plane 4211 and the first frictional rotational plane 411, thereby serving to reduce damage due to friction.

The above-described first sealing unit 4 can prevent seawater from being introduced into the engine room even if the second sealing unit 5 causes leakage of seawater. That is, the apparatus 1 of the present invention adopts a double seawater prevention configuration for completely preventing generation of bilge water.

The first press piece 422 is supported by the cover 7 and serves to apply a pressure to the first frictional stationary piece 421 so as to allow the first frictional stationary piece 421 to come into contact with the first frictional rotator 41. Thereby, the first press piece 422 allows the first frictional stationary plane 4211 and first frictional rotational plane 411 to come into strong close contact with each other.

Even if the first frictional stationary plane 4211 and first frictional rotational plane 411 are partially worn by friction, the first press piece 422 is able to provide the first frictional stationary piece 421 with a press force suitable to compensate for the resulting wear, thereby allowing the first frictional stationary piece 421 and first frictional rotator 41 to come into close contact with each other. That is, even if the first frictional stationary plane 4211 and first frictional rotational plane 411 are partially worn by friction, the first press piece 422 can automatically compensate for the wear.

Accordingly, the apparatus for preventing generation of bilge water in a ship in accordance with the present invention can extend exchange periods of the first frictional stationary piece 421 and first frictional rotator 41 while maintaining convenience in use and safety thereof.

The first press piece 422 includes a first elastic member 4221 and a first housing 4222.

The first elastic member 4221 is coupled, at one side thereof, to the cover 7 and at the other side thereof, to the first frictional stationary piece 421. The first elastic member 4221, as shown in FIG. 4, may be caught by and coupled to the cover 7.

The first elastic member 4221 provides the first press piece 422 with elasticity sufficient to apply a pressure to the first frictional stationary piece 421. The first elastic member 4221 serves to seal a coupling interface between the cover 7 and the first press piece 422. The first elastic member 4221 serves to seal a coupling interface between the first frictional stationary piece 421 and the first press piece 422. The first elastic member 4221 may be a bellows, more particularly, a rubber bellows.

The first housing 4222 is coupled around an outer periphery of the first elastic member 4221 and thus, serves to assist the first elastic member 4221 in keeping a desired external appearance thereof. The first housing 4222 reinforces the function of the first elastic member 4221 that provides the first press piece 422 with elasticity sufficient to apply a pressure to the first frictional stationary piece 421, thereby being capable of reinforcing the above-described automatic compensation function of the first press piece 422.

The first housing 4222 comprises a first stationary body 4222a, a first movable body 4222b, and a first elastic element 4222c.

The first stationary body 4222a is coupled to a portion of the first elastic member 4221 to be coupled to the cover 7, i.e. to one side of the outer periphery of the first elastic member 4221. The first stationary body 4222a has a hollow disk form suitable to receive the first elastic member 4221 therein. The first stationary body 4222a may have a plurality of protrusions, which are provided at a surface of the first stationary body 4222a facing the first movable body 4222b while being spaced apart from one another by a desired distance.

The first movable body 4222b is coupled to a portion of the first elastic member 4221 to be coupled to the first frictional stationary piece 421, i.e. to the other side of the outer periphery of the first elastic member 4221. If the first frictional rotator 41 and first frictional stationary piece 421 are partially worn, the first movable body 4222b is moved toward the first frictional stationary piece 421 so as to apply a pressure to the first frictional stationary piece 421 to compensate for the resulting wear.

The first movable body 4222b has approximately the same shape as the first stationary body 4222a. The first movable body 4222b may be coupled to the first stationary body 4222a by means of the first elastic element 4222c such that they are opposite each other. Similarly, the first movable body 4222b may have a plurality of protrusions, and the protrusions of the first movable body 4222b and first stationary body 4222a may be arranged alternately.

The first elastic element 4222c serves to elastically couple the first stationary body 4222a and first movable body 4222b to each other. The first elastic element 4222c is coupled, at one side thereof, to the first stationary body 4222a and at the other side thereof, to the first movable body 4222b. The first elastic element 4222c may be a spring having desired elasticity.

Referring to FIGS. 2 to 4, the second sealing unit 5 is located inside the cover 7 and is interposed between the other side of the first coupler 31 and the cover flange 2. The second sealing unit 5 has constituent elements approximately consistent with those of the first sealing unit 4. On the basis of the first coupler 31, the second sealing unit 5 is coupled to the other side of the first coupler 31 in an opposite direction of the first sealing unit 4.

The second sealing unit 5 may be interposed between the other side of the first coupler 31 and the cover flange 2 such that it is spaced apart from the shaft 91 by a predetermined distance. With this arrangement, even if the shaft 91 is deviated from an original position thereof, for example, is tilted by a predetermined angle according to sailing conditions of the ship, the second sealing unit 5 can normally perform a desired sealing function.

The second sealing unit 5 includes a second frictional rotator 51 and a second stator 52.

The second frictional rotator 51 is coupled to the other side of the first coupler 31 and is rotated along with the rotating unit 3 and shaft 91 simultaneously with rotation of the shaft 91. The second frictional rotator 51 has a hollow disk form.

The second frictional rotator 51 is inserted into and coupled to the rotating unit 3 so as not to come into contact with the shaft 91. This coupling manner reduces a total contact area between the shaft 91 and other elements, minimizing damage to the shaft 91 and other elements.

The second frictional rotator 51, as shown in FIG. 4, is formed with a groove 51a in a surface thereof to be coupled to the first coupler 31, such that the second frictional rotator 51 can be coupled to the other side of the first coupler 31 using the pin 200 (See FIG. 4).

The second frictional rotator 51 is defined with a second frictional rotational plane 511 and contains a second packing member 512.

The second frictional rotational plane 511 is brought into frictional contact with the second stator 52 upon rotation of the shaft 91. The second frictional rotational plane 511 may be made of any one of highly wear-resistant silicon carbide, tungsten carbide, or carbon graphite. The entire second frictional rotator 51 may be made of the same material as that of the second frictional rotational plane 511.

Accordingly, in the apparatus 1 for preventing generation of bilge water in accordance with the present invention, any elements subjected to friction upon rotation of the shaft 91 are made of highly wear-resistant materials, resulting in a reduction in frictional damage thereof and enabling long-term use without exchange.

The second packing member 512 is fitted into a receiving groove 51b defined in the second frictional rotator 51 and serves to seal a coupling interface between the second frictional rotator 51 and the first coupler 31. The second packing member 512 is supported by the second support 313. The second packing member 512 may be an O-ring and in particular, may be an O-ring made of fluorine rubber (FPM).

The second stator 52 is interposed between the cover flange 2 and the second frictional rotator 51. The second stator 52 comprises a second frictional stationary piece 521 and a second press piece 522.

The second frictional stationary piece 521 is brought into come into contact with the second frictional rotator 51 upon receiving a pressure applied by the second press piece 522. The second frictional stationary piece 521 has a hollow disk form. The second frictional stationary piece 521 is defined with a second frictional stationary plane 5211.

The second frictional stationary plane 5211 is brought into come into frictional contact with the second frictional rotational plane 511 upon rotation of the shaft 91. The second frictional stationary plane 5211 may be made of any one of highly wear-resistant silicon carbide, tungsten carbide, or carbon graphite.

The second frictional stationary plane 5211 may be made of a different material from that of the second frictional rotational plane 511. The entire second frictional stationary piece 521 may be made of the same material as that of the second frictional stationary plane 5211.

Here, note that no packing member is interposed between the second frictional stationary plane 5211 and the second frictional rotational plane 511. This allows the second frictional stationary plane 5211 and second frictional rotational plane 511 to come into strong close contact with each other via operation of the second press piece 522 and also, eliminates a risk of leakage of seawater or fluid via frictional removal of seawater or fluid. In other words, the seawater or fluid acts to remove frictional heat generated between the second frictional stationary plane 5211 and the second frictional rotational plane 511, thereby serving to reduce damage due to friction.

The second press piece 522 is supported by the cover flange 2 and serves to apply a pressure to the second frictional stationary piece 521 so as to allow the second frictional stationary piece 521 to come into contact with the second frictional rotator 51. Thereby, the second press piece 522 allows the second frictional stationary plane 5211 and second frictional rotational plane 511 to come into strong close contact with each other.

Even if the second frictional stationary plane 5211 and second frictional rotational plane 511 are partially worn by friction, the second press piece 522 is able to provide the second frictional stationary piece 521 with a press force suitable to compensate for the resulting wear, thereby allowing the second frictional stationary piece 521 and second frictional rotator 51 to come into close contact with each other. That is, even if the second frictional stationary plane 5211 and second frictional rotational plane 511 are partially worn by friction, the second press piece 522 can automatically compensate for the wear.

Accordingly, the apparatus for preventing generation of bilge water in accordance with the present invention can extend exchange periods of the second frictional stationary piece 521 and second frictional rotator 51 while maintaining convenience in use and safety thereof.

The second press piece 522 includes a second elastic member 5221 and a second housing 5222.

The second elastic member 5221 is coupled, at one side thereof, to the cover flange 2 and at the other side thereof, to the second frictional stationary piece 521. The second elastic member 5221, as shown in FIG. 4, may be caught by and coupled to the cover flange 2.

The second elastic member 5221 provides the second press piece 522 with elasticity sufficient to apply a pressure to the second frictional stationary piece 521 and also, serves to seal a coupling interface between the cover flange 2 and the second frictional stationary piece 521. The second elastic member 5221 may be a bellows, more particularly, a rubber bellows.

The second housing 5222 is coupled around an outer periphery of the second elastic member 5221 and thus, serves to assist the second elastic member 5221 to keep a desired external appearance thereof. The second housing 5222 reinforces the function of the second elastic member 5221 that provides the second press piece 522 with elasticity sufficient to apply a pressure to the second frictional stationary piece 521, thereby being capable of reinforcing the above-described automatic compensation function of the second press piece 522.

The second housing 5222 comprises a second stationary body 5222a, a second movable body 5222b, and a second elastic element 4222c.

The second stationary body 5222a is coupled to a portion of the second elastic member 5221 to be coupled to the cover flange 2, i.e. to one side of the outer periphery of the second elastic member 5221. The second stationary body 5222a has a hollow disk form suitable to receive the second elastic member 5221 therein. The second stationary body 5222a may have a plurality of protrusions, which are provided at a surface of the second stationary body 5222a facing the second movable body 5222b while being spaced apart from one another by a desired distance.

The second movable body 5222b is coupled to a portion of the second elastic member 5221 to be coupled to the second frictional stationary piece 521, i.e. to the other side of the outer periphery of the second elastic member 5221. If the second frictional rotator 51 and second frictional stationary piece 521 are partially worn, the second movable body 5222b is moved toward the second frictional stationary piece 521 so as to apply a pressure to the second frictional stationary piece 521 to compensate for the resulting wear.

The second movable body 5222b has approximately the same shape as the second stationary body 5222a. The second movable body 5222b may be coupled to the second stationary body 5222a by means of the second elastic element 5222c such that they are opposite each other. Similarly, the second movable body 5222b may have a plurality of protrusion, and the protrusions of the second movable body 5222b and second stationary body 5222a may be arranged alternately.

The second elastic element 5222c serves to elastically couple the second stationary body 5222a and second movable body 5222b to each other. The second elastic element 5222c is coupled, at one side thereof, to the second stationary body 5222a and at the other side thereof, to the second movable body 5222b. The second elastic element 5222c may be a spring having desired elasticity.

Referring to FIGS. 2 to 4, the sealing piece 6 is interposed in a contact region between the rotating unit 3 and the shaft 91, allowing seawater to be introduced only immediately in front of the sealing piece 6.

To completely prevent seawater from being introduced into the engine room, the sealing piece 6 may be made of fluorine rubber (FPM) that is not easily deformed even upon receiving a large external force, such as hydraulic force of seawater. Fluorine rubber is also referred to as “Viton”. The sealing piece 6 may have a circular loop form.

The sealing piece 6 may be fitted into the sealing groove 311 defined in the first coupler 31, to allow seawater to be introduced into the second sealing unit 5. Accordingly, the introduced seawater is used to remove frictional heat generated between the second frictional rotational plane 511 and the second frictional stationary plane 5211 of the second sealing unit 5.

Referring to FIGS. 2 to 4, the cover 7 is coupled to the other side of the cover flange 2. Both the first sealing unit 4 and second sealing unit 5 are coupled, respectively, to inner positions of the cover 7.

The cover 7 may be coupled to the cover flange 2 such that the cover 7 is spaced apart from the shaft 91 by a predetermined distance so as not to come into contact with the shaft 91. This reduces a total contact area between the shaft 91 and other elements, minimizing damage to the shaft 91 and other elements.

Fluid may be received in the cover 7. The fluid may be received in a space defined by an inner peripheral surface of the cover 7, an outer peripheral surface of the first sealing unit 4, an outer peripheral surface of the second sealing unit 5, an outer peripheral surface of the first coupler 31, and a surface of the cover flange 2. The fluid received within the cover 7 may be oil or cooling water.

When the cover 7 is configured to receive the fluid therein, the fluid serves to remove frictional heat generated between the first frictional rotational plane 411 and first frictional stationary plane 4211 of the first sealing unit 4, thereby preventing the first frictional rotational plane 411 and first frictional stationary plane 4211 from being damaged or worn by friction.

The fluid received in the cover 7 also serves to remove frictional heat generated between the second frictional rotational plane 511 and second frictional stationary plane 5211 of the second sealing unit 5, thereby preventing the second frictional rotational plane 511 and second frictional stationary plane 5211 from being damaged or worn by friction.

With the above-described configuration wherein the fluid is received within the cover 7, the apparatus for preventing generation of bilge water in a ship can remove frictional heat generated from the first sealing unit 4 and second sealing unit 5 upon starting of a ship, thereby more effectively preventing damage to the respective constituent elements thereof. A frictional force generated from the first sealing unit 4 and second sealing unit 5 is maximal upon starting of a ship, resulting in maximum frictional heat in proportion thereto.

Further, with the above-described configuration wherein the fluid is received within the cover 7, even upon high-speed operation of a ship, the apparatus for preventing generation of bilge water in a ship can remove frictional heat generated from the second sealing unit 5, preventing damage to the respective constituent elements thereof. Upon high-speed operation of a ship, the head of the ship rises to the water surface, causing the hull to be tilted and preventing seawater from being introduced into a gap between the second sealing unit 5 and the shaft 91.

The cover 7 may be made of at least one of stainless steel, titanium, and Hastelloy-C. The cover 7 may be made of plastic, to make the apparatus 1 lightweight.

The cover 7 has an inlet 71 through which the fluid to be received in the cover 7 is introduced, and an outlet 72 through which the fluid is discharged.

The inlet 71 and outlet 72 are connected to a cooling water pump (not shown) that is installed in the ship to cool an engine, enabling circulation of the fluid between the interior of the cover 7 and the cooling water pump. With this circulation, even if the fluid received within the cover 7 is increased in temperature in proportion to adsorbed frictional heat, it is possible to prevent deterioration in the cooling effect of the fluid.

The apparatus 1 may further include a sensor (not shown).

The sensor serves to sense a pressure of the fluid received within the cover 7. As will be appreciated, wear of or damage to the respective constituent elements of the apparatus 1 causes leakage of the fluid received within the cover 7 and consequently, there is a variation in pressure of the fluid sensed by the sensor.

The sensor is connected to a sound generating device. The sound generating device is capable of generating an alarm sound or transmitting a desired message to a steering house of the ship if the sensor senses a variation in pressure of the fluid received within the cover 7, thereby allowing the worker to be forewarned of the leakage of seawater or cooling fluid.

Accordingly, by allowing the worker to sense whether or not the apparatus 1 is leaking seawater or fluid, it is possible to prevent generation of bilge water and ship foundering, and also, to accurately check exchange and repair times of the respective constituent elements.

The cover 7 further has a cover protrusion 73 corresponding to the flange protrusion 22 of the cover flange 2.

The cover protrusion 73 protrudes inward from one side of the cover 7 adjacent to the first sealing unit 4 and may have a hollow disk form. As shown in FIG. 4, the first sealing unit 4 may be caught by and coupled to the cover protrusion 73.

Referring to FIGS. 2 to 5, the apparatus 1 may further include positioners 8.

The positioners 8 are supported by an outer surface 7a (See FIG. 4) of one side of the cover 7 and are detachably coupled to the second coupler 32. Specifically, the positioners 8 may be detachably coupled to the second coupler 32 by use of at least one fastener. The positioners 8 are used only upon installation of the apparatus 1, and may be removed after completion of installation.

The positioners 8 may have an L-shaped form. The outer surface 7a (See FIG. 4) of the cover 7 is formed with recesses 7b (See FIG. 4) into which one end of the respective positioners 8 can be inserted.

The positioners 8 serve to determine a coupling position of the rotating unit 3 with respect to the shaft 91. As the positioners 8 are supported by the outer surface 7a (See FIG. 4) of one side of the cover 7, the rotating unit 3 can be coupled to the shaft 91 in a state wherein the first and second couplers 31 and 32 are spaced apart from the outer surface 7a (See FIG. 4) of one side of the cover 7 by a predetermined distance. In this way, the rotating unit 3, first sealing unit 4, second sealing unit 5 and sealing piece 6 can be coupled at accurate positions.

The positioners 8 enable the apparatus 1 to be installed at an accurate position in an integrally assembled state thereof as shown in FIG. 5. The use of the positioners 8 contributes to convenient and easy installation.

Hereinafter, another preferred embodiment of the apparatus for preventing generation of bilge water in a ship will be described in detail with reference to the accompanying drawings. Some constituent elements of the apparatus for preventing generation of bilge water according to the following preferred embodiment are similar to those of the previously described embodiment, and thus, description thereof will be omitted so as not to make the subject matter of the present invention unclear.

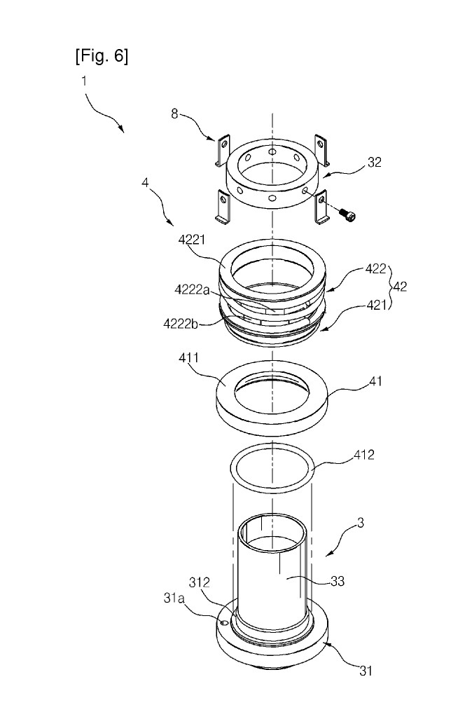

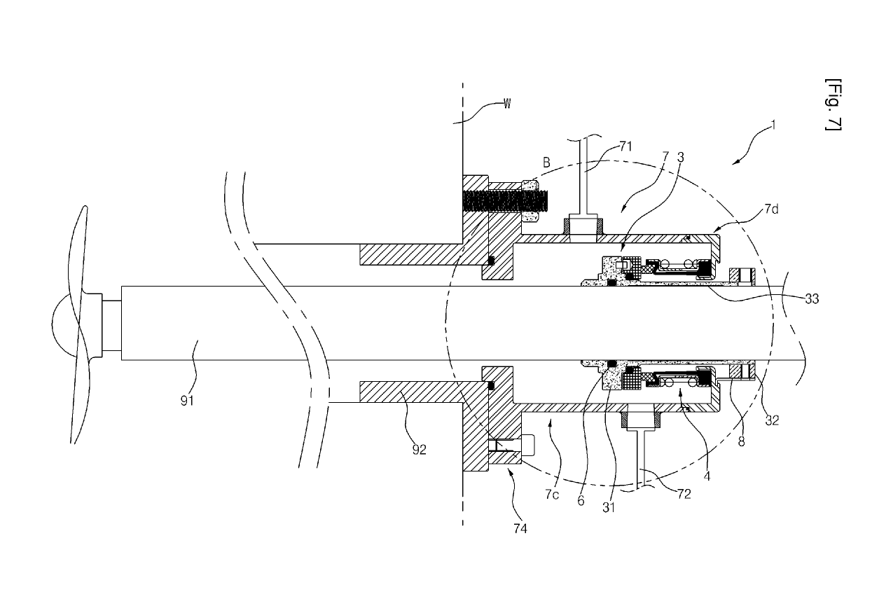

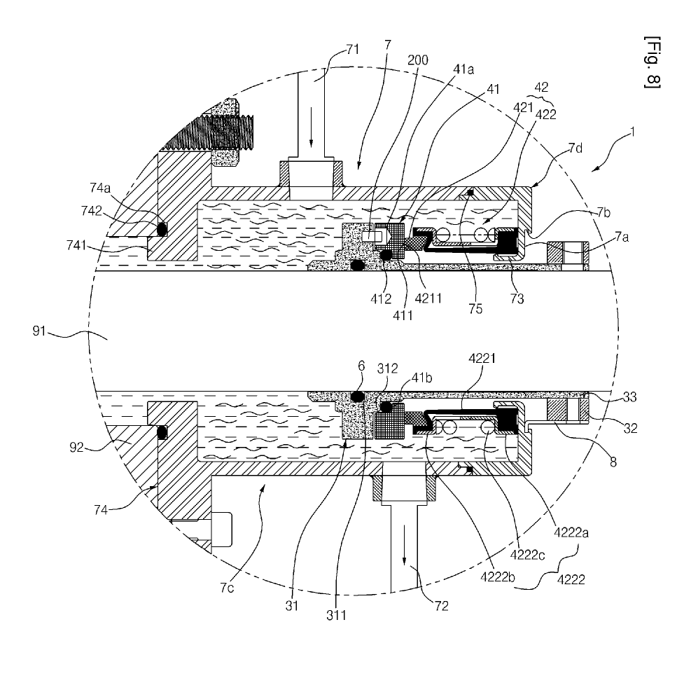

FIG. 6 is an exploded perspective view illustrating a partial configuration of an apparatus for preventing generation of bilge water in a ship in accordance with another exemplary embodiment of the present invention. FIG. 7 is a sectional view illustrating a state wherein the apparatus for preventing generation of bilge water in a ship shown in FIG. 6 is mounted to a ship. FIG. 8 is an enlarged sectional view of the portion B in FIG. 7.

Referring to FIGS. 6 and 7, differently from the previously described embodiment, the apparatus for preventing generation of bilge water according to the present embodiment basically includes the first coupler 31 and the cover 7.

Also, differently from the previously described embodiment, the apparatus according to the present embodiment is configured in such a manner that the cover flange 2 (See FIG. 3) is integrally formed with the cover 7 and no second sealing unit 5 (See FIG. 3) is provided. Accordingly, the apparatus 1 according to the present embodiment exhibits a further simplified configuration as compared to the previously described embodiment and has an advantage of being installed to a ship via further simplified work.

Referring to FIGS. 6 and 7, the first coupler 31 is coupled, at one side thereof, to the second sealing unit 4. The first coupler 31 may have a hollow disk form. The rotating unit 3 may be coupled to the shaft 91 such that the first coupler 31 is located inside the cover 7. The first coupler 31 is formed with the groove 31a such that the first coupler 31 is coupled to the first sealing unit 4 by means of the pin 200 (See FIG. 8).

The first coupler 31 is also formed with the sealing groove 311 (See FIG. 8). The sealing groove 311 is a groove into which the sealing piece 6 is fitted. The sealing groove 311 is formed in the inner peripheral surface of the first coupler 31 defining a penetration bore through which the shaft 91 is penetrated. The sealing groove 311 may have a shape complement to the sealing piece 6.

The first coupler 31 includes the first support 312.

The first support 312 is used to support the first packing member 412, which is provided to seal a coupling interface between the rotating unit 3 and the first sealing unit 4. The first support 312 is a stepped portion defined at one side of the first coupler 31 and may have a hollow disk form.

Referring to FIGS. 6 to 8, fluid may be received in the cover 7. Specifically, the fluid may be received in a space defined by the inner peripheral surface of the cover 7, the outer peripheral surface of the first sealing unit 4 and the outer peripheral surface of the first coupler 31. The fluid received within the cover 7 may be at least one of seawater or cooling water.

When the cover 7 is configured to receive fluid therein, it is possible to remove frictional heat generated upon friction between the first frictional rotational plane 411 and first frictional stationary plane 4211 of the first sealing unit 4. This can prevent wear of or damage to the first frictional rotational plane 411 and first frictional stationary plane 4211 by friction.

Furthermore, with the above-described configuration wherein fluid is received within the cover 7, the apparatus for preventing generation of bilge water in a ship can remove frictional heat generated from the first sealing unit 4 upon starting of a ship, thereby more effectively preventing damage to the respective constituent elements thereof. A frictional force generated from the first sealing unit 4 becomes the maximum upon starting of a ship, resulting in maximum frictional heat in proportion thereto.

The cover 7 may be made of at least one of stainless steel, titanium and hastelloy-C. The cover 7 may be made of plastic, to make the apparatus 1 lightweight.

The cover 7 may have the inlet 71 and outlet 72.

The inlet 71 and outlet 72 are connected to a cooling water pump (not shown) that is installed in the ship to cool an engine, enabling circulation of the fluid between the interior of the cover 7 and the cooling water pump. With this circulation, even if the fluid received within the cover 7 is increased in temperature in proportion to adsorbing frictional heat, it is possible to prevent deterioration in the cooling effect of fluid.

If necessary, a pressure of cooling water circulated through the inlet 71 and outlet 72 can be adjusted. This enables impurities introduced into the ship along with seawater to be again discharged to the outside, thereby preventing damage to the apparatus 1.

The apparatus for preventing generation of bilge water may further include a sensor (not shown).

The sensor serves to sense a pressure of the fluid received within the cover 7. As will be appreciated, wear of or damage to the respective constituent elements of the apparatus 1 causes leakage of the fluid received within the cover 7 and consequently, there is a variation in pressure of the fluid sensed by the sensor.

The sensor is connected to a sound generating device. The sound generating device is capable of generating an alarm sound or transmitting a desired message to a steering house of the ship if the sensor senses a variation in pressure of the fluid received within the cover 7 beyond a predetermined range, thereby allowing the worker to be forewarned of the leakage of seawater or cooling fluid.

Accordingly, by allowing the worker to detect whether or not the apparatus 1 for preventing generation of bilge water is leaking seawater or fluid, it is possible to prevent generation of bilge water and ship foundering, and also, to accurately check exchange and repair times of the respective constituent elements.

The cover 7 further has the cover protrusion 73 and a cover flange 74.

The cover protrusion 73 protrudes inward from one side of the cover 7 and may have a hollow disk form. As shown in FIG. 8, the first sealing unit 4 may be caught by and coupled to the cover protrusion 73.

The cover flange 74 may have a hollow disk form and the shaft 91 is penetrated through the center of the cover flange 74. The cover flange 74 may be coupled to the stern tube 92. In this case, the cover flange 74 may be coupled to the stern tube 92 such that the cover flange 74 is spaced apart from the shaft 91 by a predetermined distance so as not to come into contact with the shaft 91.

Although not shown, the cover flange 74 may be coupled to any one of the wall surface W of the engine room or bushing (not shown), instead of the stern tube 92. That is, in consideration of ship installation options or easy installation, the worker is able to couple the cover flange 74 to any one of the wall surface W of the engine room, stern tube 92 and bushing (not shown).

The cover flange 74 may include an inserting portion 741 and a flange packing member 742.

The inserting portion 741 protrudes from one side of the cover flange 74 and may have a hollow disk form. When the cover flange 74 is coupled to the stern tube 92, the inserting portion 741 is inserted into the stern tube 92. Using the inserting portion 741 makes it for the worker to easily mount the apparatus 1 to the ship.

The flange packing member 742 is fitted into a packing groove 74a (See FIG. 8) formed at one side of the cover flange 74, and serves to seal a coupling interface between the cover flange 74 and the stern tube 92. The flange packing member 23 may be an O-ring, and in particular, may be an O-ring made of fluorine rubber (FPM).

Although not shown, a plurality of flange packing members 742 may be provided. In this case, the cover flange 74 may be formed with a plurality of packing grooves 74a corresponding to the number of the flange packing members 742.

Although not shown, when the cover flange 74 is coupled to any one of the wall surface W of the engine room or bushing (not shown) instead of the stern tube 92, the flange packing member 742 may be coupled to one side of the cover flange 74 so as to seal the resulting coupling interface.

Referring to FIGS. 6 to 8, the cover 7 may consist of a first cover 7c and second cover 7d, which are detachably coupled to each other.

As the first and second covers 7c and 7d are detachably coupled to each other, the rotating unit 3 and first sealing unit 4 can be easily coupled to the cover 7. Although not shown, the first cover 7c and second cover 7d may be detachably coupled to each other by use of fasteners such as bolts, etc.

The first cover 7c may include the cover flange 74 coupled to any one of the wall surface W of the engine room, stern tube 92 and bushing.

The second cover 7d may be coupled to the first cover 7c such that the second cover 7d comes into contact with the first sealing unit 4 while being spaced apart from the shaft 91. This reduces a contact area between the shaft 91 and other elements, minimizing damage to the shaft 91 and other elements.

The second cover 7d may include the cover protrusion 73, which is caught by and coupled to the first sealing unit 4. The second cover 7d also may be formed at the outer surface 7a (See FIG. 8) of one side thereof with the groove 7d (See FIG. 8) into which one end of the respective positioners 8 is inserted. At least one cover packing member 75 may be interposed in a coupling interface between the second cover 7d and the first cover 7c.

The cover packing member 75 serves to seal the coupling interface between the first cover 7c and the second cover 7d. Alternatively, a plurality of cover packing members 75 may be provided. The cover packing member 75 may be an O-ring, and in particular, may be an O-ring made of fluorine rubber (FPM).

Note that, although the apparatus 1 for preventing generation of bilge water according to the present invention is described herein under the assumption that most the above-described constituent elements have a circular cross section, these constituent elements may have a polygonal cross section.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for preventing generation of bilge water in a ship comprising:
a cover configured to receive fluid therein;
a rotating unit coupled to a shaft so as to be rotated along with the shaft penetrated through the rotating unit, wherein the rotating unit includes a first coupler;
a first sealing unit located inside the cover and interposed between one side of the first coupler and one side of the cover; and
a sealing piece interposed in a contact interface between the rotating unit and the shaft.

2. The apparatus according to claim 1, wherein the first sealing unit includes:
a first frictional rotator coupled to one side of the first coupler and adapted to be rotated along with the shaft; and
a first stator including a first frictional stationary piece to be brought into contact with the first frictional rotator.

3. The apparatus according to claim 2, wherein the first stator further includes a first press piece supported by the cover, wherein the first press piece serves to apply a pressure to the first frictional stationary piece so as to allow the first frictional stationary piece to come into contact with the first frictional rotator.

4. The apparatus according to claim 3, wherein the first press piece include a first elastic member, wherein the first elastic member is coupled at one side thereof to the cover and at the other side thereof to the first frictional stationary piece.

5. The apparatus according to claim 4, wherein the first press piece further includes a first housing coupled around an outer periphery of the first elastic member.

6. The apparatus according to claim 5, wherein the first housing includes:
a first stationary body coupled to one side of the outer periphery of the first elastic member;
a first movable body coupled to the other side of the outer periphery of the first elastic member; and
a first elastic element to elastically couple the first stationary body and first movable body to each other.

7. The apparatus according to claim 2, wherein the first frictional rotator includes a first packing member to seal a coupling interface between the first coupler and the first frictional rotator; and
wherein the first coupler includes a first support to support the first packing member.

8. The apparatus according to claim 1, wherein the cover includes an inlet through which the fluid is introduced into the cover, and an outlet through which the fluid is discharged out of the cover.

9. The apparatus according to claim 1, further comprises a sensor to sense a pressure of the fluid received within the cover.

10. The apparatus according to claim 1, wherein the first sealing unit is interposed between one side of the first coupler and the cover such that the first sealing unit is spaced apart from the shaft.

11. The apparatus according to claim 1, wherein the cover includes a cover flange coupled to any one of a wall surface of an engine room, a stern tube and a bushing; and
wherein the cover flange has at least one packing groove, into which a flange pac king member is inserted to seal a coupling interface between the cover flange and any one of the wall surface of the engine room, stern tube and bushing.

12. The apparatus according to claim 1, wherein the cover includes a first cover and a second cover detachably coupled to each other;
wherein the first cover includes a cover flange coupled to any one of a wall surface of an engine room, a stern tube, and a bushing; and
wherein the second cover is coupled to the first cover such that the second cover comes into contact with the first sealing unit while being spaced apart from the shaft.

13. The apparatus according to claim 12, further comprises at least one cover packing member interposed in a coupling interface between the first cover and the second cover.

14. The apparatus according to claim 1, wherein the rotating unit further includes a second coupler coupled to the shaft at the outside of the cover; and
wherein the apparatus further includes at least one positioner supported by an outer surface of the cover and detachably coupled to the second coupler.

15. The apparatus according to claim 14, wherein the sealing piece is coupled to the first coupler, and wherein the rotating unit further includes a connector to connect the first coupler located inside the cover and a second coupler located at the outside of the cover to each other.

16. The apparatus according to claim 2, wherein the first frictional rotator includes a first frictional rotational plane to be brought into frictional contact with the first frictional stationary piece; and
wherein the first frictional rotational plane is made of any one of silicon carbide, tungsten carbide, or carbon graphite.

17. The apparatus according to claim 2, wherein the first frictional stationary piece includes a first frictional stationary plane to be brought into frictional contact with the first frictional rotational plane; and
wherein the first frictional stationary plane is made of any one of silicon carbide, tungsten carbide, or carbon graphite.

18. The apparatus according to claim 1, further comprising:
a cover flange coupled to the other side of the cover; and
a second sealing unit located inside the cover and interposed between the other side of the first coupler and the cover flange.

19. The apparatus according to claim 18, wherein the second sealing unit includes:
a second frictional rotator coupled to the other side of the first coupler and adapted to be rotated along with the shaft; and
a second stator including a second frictional stationary piece to be brought into contact with the second frictional rotator.

20. The apparatus according to claim 19, the second stator further includes a second press piece supported by the cover flange and serving to apply a pressure to the second frictional stationary piece so as to allow the second frictional stationary piece to come into contact with the second frictional rotator.

21. The apparatus according to claim 20, wherein the second press piece include a second elastic member, wherein the second elastic member is coupled at one side thereof to the cover flange and at the other side thereof to the second frictional stationary piece.

22. The apparatus according to claim 21, wherein the second press piece further includes a second housing coupled around an outer periphery of the second elastic member.

23. The apparatus according to claim 22, wherein the second housing includes:
a second stationary body coupled to one side of the outer periphery of the second elastic member;
a second movable body coupled to the other side of the outer periphery of the second elastic member; and
a second elastic element to elastically couple the second stationary body and second movable body to each other.

24. The apparatus according to claim 19, wherein the second frictional rotator includes a second packing member to seal a coupling interface between the first coupler and the second frictional rotator; and
wherein the first coupler includes a second support to support the second packing member.

25. The apparatus according to claim 18, wherein the second sealing unit is interposed between the other side of the first coupler and the cover flange such that the second sealing unit is spaced apart from the shaft; and
wherein the cover is coupled to the cover flange such that the cover is spaced apart from the shaft.

26. The apparatus according to claim 18, wherein the cover flange is coupled to any one of a wall surface of an engine room, a stern tube and a bushing;
wherein the cover flange includes at least one flange packing member to seal a coupling interface between the cover flange and any one of the wall surface of the engine room, stern tube and bushing; and
wherein at least one cover packing member to seal a coupling interface between the cover and the cover flange.

27. The apparatus according to claim 19, wherein the second frictional rotator includes a second frictional rotational plane to be brought into frictional contact with the second frictional stationary piece; and
wherein the second frictional rotational plane is made of any one of silicon carbide, tungsten carbide, or carbon graphite.

28. The apparatus according to claim 19, wherein the second frictional stationary piece includes a second frictional stationary plane to be brought into frictional contact with the second frictional rotational plane, and
wherein the second frictional stationary plane is made of any one of silicon carbide, tungsten carbide, or carbon graphite.

29. The apparatus according to claim 1, wherein the sealing piece is made of fluorine rubber.
